(19) United States
(12) Patent Application Publication
(10) Pub. No.: US 2026/0286187 A1
(43) Pub. Date: Sep. 24, 2026

(54) SLURRY THAT SUPPRESSES REDUCTION OF LIFETIME OF POLISHING PAD AND METHOD FOR EVALUATING DAMAGE CAUSED BY SLURRY TO POLISHING PAD

(71) Applicant: FUJIMI INCORPORATED, Aichi (JP)

(72) Inventor: Emi Narita, Aichi (JP)

(21) Appl. No.: 19/556,332

(22) Filed: Mar. 4, 2026

(30) Foreign Application Priority Data
Mar. 24, 2025 (JP) 2025-047838

(51) Int. Cl. C09G 1/04; B24B 37/005; B24B 37/04

(52) U.S. Cl. CPC C09G 1/04; B24B 37/005; B24B 37/044

(57) ABSTRACT

An object to be solved by the present invention is to provide a technique for suppressing the short lifetime of a polishing pad with an approach completely different from conventionally known approaches. A slurry having a property of suppressing the wear amount of a polishing pad, as determined in Wear Amount Test X, to 0.037 mm³ or less.

### TECHNICAL FIELD

The present invention relates to a slurry and an evaluation method of a polishing pad.

### BACKGROUND ART

In recent years, a so-called chemical mechanical polishing (CMP) technique for polishing and flattening a semiconductor substrate in production of a device is utilized in accordance with multilayer wiring on a surface of a semiconductor substrate. CMP is a method for flattening the surface of an object to be polished such as a semiconductor substrate by using a polishing composition containing abrasive grains such as silica, alumina, or ceria, an anti-corrosion agent, and a surfactant. The object to be polished is a silicon-containing material such as silicon, polysilicon, silicon oxide, or silicon nitride, or a wiring or a plug made of metal or the like.

On the surface of a semiconductor substrate after a CMP step, impurities may remain in a large amount. Impurities may include abrasive grains, metals, anti-corrosion agents, and organic materials such as surfactants that are derived from a polishing composition used for CMP; silicon-containing materials and metals that are generated by polishing of a silicon-containing material as an object to be polished, a metal wiring, or a plug; and further, organic materials such as pad debris that are generated from various pads. When the surface of a semiconductor substrate is contaminated with these impurities, this may adversely affect the electrical properties of a semiconductor and may leads to a reduction in device reliability. Thus, it is desirable to remove these impurities from the surface of a semiconductor substrate by introducing a cleaning step after the CMP step.

As such a cleaning composition, for example, Patent Literature 1 discloses a rinsing composition for a silicon wafer that satisfies specific conditions and contains a water-soluble polymer, and discloses that this rinsing composition can remove foreign matters on a silicon wafer after polishing and can reduce defects of the silicon wafer after polishing.

By the way, consumption articles (e.g., polishing pads) used in CMP or the post CMP process (rinsing process) are required to have a long lifetime in the semiconductor industry, from the viewpoint of costs and environmental protection. For example, Patent Literature 2 provides a polishing cloth with a long lifetime, high smoothness, and a high rate by evaluating the lightness of an untreated polishing cloth immediately after production.

### CITATION LIST

### Patent Literature

Patent Literature 1: Japanese Patent Laid-Open No. 2020-167237
Patent Literature 2: Japanese Patent Laid-Open No. 2014-12322

### SUMMARY OF INVENTION

### Technical Problem

Although Patent Literature 2 employs an approach that is intended to prolong the lifetime of a polishing pad from a structural viewpoint of the polishing pad, an object to be solved by the present invention is to provide a technique for suppressing the short lifetime of the polishing pad with an approach completely different from the above approach. Another object is to provide a novel evaluation method associated therewith.

### Solution to Problem

The above object can be solved by a slurry having a property of suppressing the wear amount of a polishing pad, as determined in Wear Amount Test X, to 0.037 mm³ or less. In addition, the above object is solved by a method for evaluating damage caused by a slurry to a polishing pad, including a step of subjecting the slurry and the polishing pad to contact treatment to obtain a treated pad, a step of applying scratches to the treated pad using a static friction measuring machine, and a step of obtaining a wear amount value of the polishing pad from the volume of the scratches using a laser microscope.

### Effect of the Invention

The present invention can provide a technique for suppressing the short lifetime of the polishing pad with a novel approach. In particular, the above evaluation method includes a step of bringing a slurry and a polishing pad into slide contact with each other, typically a step of bringing a polishing pad into contact with an object to be polished or a polished object to be polished, and relatively sliding the polishing pad and the object to be polished or the polished object to be polished while supplying a slurry to the contact part, and thus, the damage caused by the slurry to the polishing pad can be evaluated in consideration of the mechanical stimulation of sliding. By using the damage as an index, a slurry that enables a long lifetime of the polishing pad can be effectively designed.

### BRIEF DESCRIPTION OF DRAWING

FIG. 1 shows a schematic view of a treated polishing pad in which two scratches have been made so that they traverse five grid cells each, thereby providing a total of ten scratched grid cells on the pad.

### DESCRIPTION OF EMBODIMENTS

In the present specification, “X to Y” is used as a meaning including numerical values described before and after “to” (X and Y) as the lower limit value and the upper limit value, and means “X or more and Y or less”. When a plurality of “X to Y” is described, for example, when there is a description of “X1 to Y1, or X2 to Y2” or “X1 or more and Y1 or less, or X2 or more and Y2 or less”, all of the disclosure using each numerical value as the upper limit, the disclosure using each numerical value as the lower limit, and combinations of each upper limit and each lower limit are disclosed (that is, they are legal grounds for correction). Specifically, all of correction with X1 or more, correction with Y2 or less, correction with X1 or less, correction with Y2 or more, correction with X1 to X2, correction with X1 to Y2, and the like, must be considered to be legal. Unless otherwise indicated, the operation and the measurement of physical properties and the like are performed under the conditions of room temperature (20 to 25° C.)/relative humidity of 40 to 50% RH. The concentration described herein may be a concentration at the point of use (POU) or may be a concentration before dilution to the concentration at POU. The dilution factor may be 2 to 10 times. In addition, all the embodiments and combinations of descriptions disclosed herein must be understood to be disclosed in the present application. That is, these must be understood to be grounds for correction. When the content or concentration of each component is described and two or more kinds of components are contained, the content or concentration may be of the total amount of them.

In the present specification, a slurry having a property of suppressing the wear amount of a polishing pad, as determined in Wear Amount Test X, to 0.037 mm³ or less is provided. Herein, the Wear Amount Test X refers to a test in which a polishing pad that has been subjected to chemical mechanical polishing (CMP) or post CMP cleaning treatment using a slurry is forced to be scratched using a static friction measuring machine, the wear amount of the scratch is quantitatively determined using a laser microscope, thereby evaluating the damage to the pad. A specific measurement method of the Wear Amount Test X will be described in Examples.

In the present specification, the slurry may be a slurry used in chemical mechanical polishing (CMP) or cleaning in post chemical mechanical polishing (post CMP), and is suitably a slurry used as a post CMP cleaning composition. The slurry used as the post CMP cleaning composition can sufficiently remove the defect remained on the surface of a polished object to be polished, in particular, a polished object to be polished that contains a silicon-containing material such as silicon nitride, silicon oxide, or polysilicon.

### <Polished Object to be Polished>

The polished object to be polished means an object to be polished after being polished in a polishing step (CMP step). According to an embodiment of the present invention, the polished object to be polished (object to be polished) may be silicon nitride (Si₃N₄), silicon oxide (SiO₂), polysilicon (polycrystalline silicon), a carbon-containing silicon such as silicon carbonitride (SiCN), amorphous silicon, a silicon material doped with impurities, a metal simple substance, an alloy, metal nitride, or a compound semiconductor such as SiGe. Examples of a film containing silicon oxide include a tetraethyl orthosilicate (TEOS) silicon oxide film that is produced by using tetraethyl orthosilicate as a precursor (hereinafter simply referred to as the “TEOS film”), a high density plasma (HDP) film, an undoped silicate glass (USG) film, a phosphorus silicate glass (PSG) film, a boron-phospho silicate glass (BPSG) film, and a rapid thermal oxidation (RTO) film. The film containing silicon oxide included in the polished object to be polished may be alone or a combination of two or more.

### <Slurry>

The slurry disclosed in the present specification may be a slurry having a property of suppressing the wear amount of the polishing pad, as determined in Wear Amount Test X, to 0.037 mm³ or less. According to an embodiment of the present invention, the wear amount of the polishing pad, as determined in Wear Amount Test X, may be 0.036 mm³ or less, 0.035 mm³ or less, 0.034 mm³ or less, 0.033 mm³ or less, 0.032 mm³ or less, 0.031 mm³ or less, or 0.0308 mm³ or less. According to an embodiment of the present invention, the wear amount of the polishing pad, as determined in Wear Amount Test X, is, for example, 0.020 mm³ or more. Such a slurry may be used as the polishing composition or the post CMP cleaning composition as described above, but the latter is suitable. As a preferred embodiment, an embodiment using the slurry as the post CMP cleaning composition will be described below. The post CMP cleaning composition is described as an embodiment of the slurry, and the post CMP cleaning composition may be replaced with the polishing composition that is also an embodiment of the slurry.

According to an embodiment of the present invention, a post CMP cleaning composition having a property of suppressing the wear amount of the polishing pad, as determined in Wear Amount Test X, to 0.037 mm³ or less is provided. Such a post CMP cleaning composition improves the lifetime of the polishing pad, while ensuring basic properties as a cleaning agent in post CMP. The phrase “ensuring basic properties as a cleaning agent in post CMP” may mean that, for example, when a post CMP is carried out using, as a control, a commonly used rinsing composition in the industry (post CMP cleaning composition; Comparative Example 4 in the Examples section), the present post CMP cleaning composition leaves a residual defect count equal to or less than that left by the control.

### (Surfactant)

In an embodiment of the present invention, the post CMP cleaning composition may contain or not contain a surfactant, and even when a surfactant is contained, the concentration thereof in the post CMP cleaning composition is 1000 ppm by mass or less. The surfactant is a substance having a hydrophilic group and a hydrophobic group. The hydrophilic group and the hydrophobic group will be described later. The type of surfactant is not particularly limited, and any of nonionic, anionic, cationic, and amphoteric surfactants may be used. Examples of the surfactant include alkyl ethers such as polyoxyethylene lauryl ether and polyoxyethylene oleyl ether; alkyl phenyl ethers such as polyoxyethylene octylphenyl ether; alkyl esters such as polyoxyethylene laurate; alkyl amines such as polyoxyethylene lauryl amino ether; alkyl amides such as polyoxyethylene laurylamide; polypropylene glycol ethers such as polyoxyethylene polyoxypropylene ether; alkanolamides such as oleic acid diethanolamide; and allyl phenyl ethers such as polyoxyalkylene allyl phenyl ether. Further, examples thereof include nonionic surfactants such as propylene glycol, diethylene glycol, monoethanolamine, alcohol ethoxylate, alkylphenol ethoxylate, tertiary acetylenic glycol, and alkanol amide; anionic surfactants, such as carboxylic acids such as sodium myristate, sodium palmitate, sodium stearate, sodium laurate, and potassium laurate, sulfate esters such as ammonium lauryl sulfate and sodium octyl sulfate, phosphoric acid esters such as lauryl phosphoric acid and sodium lauryl phosphate; and sulfonic acids such as sodium dioctyl sulfosuccinate and sodium dodecylbenzene sulfosuccinate; cationic surfactants, such as amines such as laurylamine hydrochloride; and amphoteric surfactants, such as lecithin, alkylamine oxide, alkylbetaine such as N-alkyl-N,N-dimethylammonium betaine, and sulfobetaine. In an embodiment of the present invention, the surfactant is polyoxyalkylene alkyl ether. The number of oxyalkylene units (average number of moles added) of polyoxyalkylene alkyl ether is, for example, 5 to 15, 6 to 14, 7 to 13, or 8 to 12. In an embodiment of the present invention, the number of carbon atoms per oxyalkylene unit of polyoxyalkylene alkyl ether is, for example, 1 to 3, or 1 or 2. In an embodiment of the present invention, the number of carbon atoms of alkyl of polyoxyalkylene alkyl ether is 7 to 18, 8 to 16, 9 to 14, or 10 to 13.

According to an embodiment of the present invention, the concentration of the surfactant contained in the post CMP cleaning composition is 900 ppm by mass or less, 800 ppm by mass or less, 700 ppm by mass or less, 600 ppm by mass or less, 500 ppm by mass or less, 400 ppm by mass or less, 300 ppm by mass or less, 200 ppm by mass or less, 150 ppm by mass or less, 100 ppm by mass or less, 50 ppm by mass or less, 10 ppm by mass or less, 5 ppm by mass or less, 1 ppm by mass or less, 0.5 ppm by mass or less, or 0.01 ppm by mass or less. According to an embodiment of the present invention, the concentration of the surfactant contained in the post CMP cleaning composition may be, for example, 50 to 200 ppm by mass.

When the concentration of the surfactant is significantly low in the post CMP cleaning composition or the post CMP cleaning composition contains no surfactant, the lifetime of the polishing pad can be improved. The mechanism is presumed as follows. However, the present invention is not limited by the mechanism. A surfactant has a hydrophobic group in its structure. The material of the polishing pad suitably used in the present invention is preferably polyurethane. Since polyurethane is hydrophobic, mutual adsorption of polyurethane and the hydrophobic group in the surfactant is promoted by the interaction therebetween. On the other hand, the surfactant also simultaneously has a hydrophilic group. Thus, when the surfactant is adsorbed to the polishing pad by the action of the hydrophobic group, the hydrophilic group thereof is also simultaneously adsorbed. This hydrophilic group is considered to have an action of making the structure of polyurethane fragile. Thus, when the concentration of the surfactant is significantly low in the post CMP cleaning composition or the post CMP cleaning composition contains no surfactant, the lifetime of the polishing pad may be improved. Herein, the hydrophilic group in the surfactant refers to a functional group having a high affinity with water, which is a group imparting a function that the surfactant is dissolved in water. Examples thereof include anionic groups such as a carboxylic acid group, a sulfonic acid group, and a phosphoric acid group; cationic groups such as an amino group and a quaternary ammonium group; nonionic groups (having neither anionic group nor cationic group), such as an ether bond and a hydroxyl group; and zwitterionic groups such as a group simultaneously containing a carboxyl group and an amino group. The hydrophobic group in the surfactant refers to a lipophilic functional group having a low affinity with water, and examples thereof include an alkyl group and an alkenyl group (e.g., about 8 to 18 carbon atoms).

### (Vinyl Polymer)

According to an embodiment of the present invention, the post CMP cleaning composition contains a vinyl polymer. The vinyl polymer is a generic term for high molecular compounds obtained by polymerizing a monomer having a vinyl group (—CH═CH₂). According to an embodiment of the present invention, the vinyl polymer is a heteroatom-containing vinyl polymer. According to an embodiment of the present invention, the heteroatom-containing vinyl polymer contains a nitrogen atom. According to an embodiment of the present invention, the heteroatom-containing vinyl polymer contains an oxygen atom. According to an embodiment of the present invention, the heteroatom-containing vinyl polymer has at least one selected from an amide bond and a hydroxy group. The vinyl polymer having an amide bond may be a polymer having an amide bond in a side chain structure. According to an embodiment of the present invention, the amide bond may be cyclic amide. Examples of the vinyl polymer having an amide bond include polyvinylpyrrolidone, poly-N-vinylacetamide, polydimethylacrylamide, polyvinylcaprolactam, or N-isopropylacrylamide. The heteroatom-containing vinyl polymer may be an oxazoline group-containing polymer.

According to an embodiment of the present invention, examples of the vinyl polymer having a hydroxy group include a polyvinyl alcohol polymer. The polyvinyl alcohol polymer may substantially contain only a vinyl alcohol unit as a repeating unit, or may contain a repeating unit other than the vinyl alcohol unit. In the case of containing a repeating unit other than the vinyl alcohol unit, the copolymer may be a block copolymer, a graft copolymer, or an alternating copolymer. Examples of the repeating unit other than the vinyl alcohol unit include a unit having at least one structure selected from an oxyalkylene group, a carboxy group, a (di)carboxylic acid group, a (di)carboxylate group, a phenyl group, a naphthyl group, a sulfo group, an amino group, a hydroxy group, an imido group, a nitrile group, an ether group, an ester group, and salts thereof. The polyvinyl alcohol substantially containing only a vinyl alcohol unit as the repeating unit is produced by hydrolyzing (saponifying) polyvinyl acetate and has a repeating unit having a structure in which vinyl acetates are vinyl polymerized. The degree of saponification may be 94% or more, 96% or more, or 98% or more.

According to an embodiment of the present invention, the vinyl polymer is at least one selected from the group consisting of polyvinylpyrrolidone, poly-N-vinylacetamide, polydimethylacrylamide, polyvinylcaprolactam, N-isopropylacrylamide, an oxazoline group-containing polymer, and a polyvinyl alcohol polymer.

According to an embodiment of the present invention, the weight average molecular weight of the vinyl polymer may be 1,500 or more, 3,000 or more, 5,000 or more, 10,000 or more, 15,000 or more, 20,000 or more, 25,000 or more, 30,000 or more, or 35,000 or more. According to an embodiment of the present invention, the weight average molecular weight of the vinyl polymer may be 1,000,000 or less, 500,000 or less, 300,000 or less, 100,000 or less, 80,000 or less, or 60,000 or less. According to an embodiment of the present invention, the weight average molecular weight of the vinyl polymer may be 1,500 or more and 60,000 or less. When the vinyl polymer has the above weight average molecular weight, the lifetime of the polishing pad can be improved.

According to an embodiment of the present invention, the content of the vinyl polymer in the post CMP cleaning composition is 50000 ppm by mass or less, 40000 ppm by mass or less, 30000 ppm by mass or less, 15000 ppm by mass or less, 13000 ppm by mass or less, 10000 ppm by mass or less, 8000 ppm by mass or less, 6000 ppm by mass or less, 4000 ppm by mass or less, 3000 ppm by mass or less, 2000 ppm by mass or less, 1000 ppm by mass or less, 800 ppm by mass or less, 600 ppm by mass or less, 400 ppm by mass or less, or 200 ppm by mass or less, based on the total mass of the post CMP cleaning composition. Particularly when the content of the vinyl polymer in the post CMP cleaning composition is less than 10000 ppm by mass, less than 1000 ppm by mass, less than 500 ppm by mass, or less than 250 ppm by mass, based on the total mass of the post CMP cleaning composition, hydrophilicity can be moderately imparted to the polishing pad, and the lifetime of the polishing pad can be significantly improved while ensuring the basic properties of reducing the number of defects of the post CMP cleaning composition. According to an embodiment of the present invention, the content of the vinyl polymer in the post CMP cleaning composition is 5 ppm by mass or more, 10 ppm by mass or more, 30 ppm by mass or more, 50 ppm by mass or more, 70 ppm by mass or more, 90 ppm by mass or more, 100 ppm by mass or more, 200 ppm by mass or more, 300 ppm by mass or more, 600 ppm by mass or more, 800 ppm by mass or more, 1000 ppm by mass or more, 3000 ppm by mass or more, 5000 ppm by mass or more, 7000 ppm by mass or more, or 9000 ppm by mass or more, based on the total mass of the post CMP cleaning composition. Particularly when the content of the vinyl polymer in the post CMP cleaning composition is more than 10 ppm by mass, based on the total mass of the post CMP cleaning composition, hydrophilicity can be moderately imparted to the polishing pad, and the lifetime of the polishing pad can be significantly improved while ensuring the basic properties of reducing the number of defects of the post CMP cleaning composition. According to an embodiment of the present invention, the content of the vinyl polymer in the post CMP cleaning composition is 5 to 15000 ppm by mass, based on the total mass of the post CMP cleaning composition. According to an embodiment of the present invention, the content of the vinyl polymer in the post CMP cleaning composition is 10 to 10000 ppm by mass, based on the total mass of the post CMP cleaning composition. According to an embodiment of the present invention, the content of the vinyl polymer in the post CMP cleaning composition is 50 to 1000 ppm by mass, based on the total mass of the post CMP cleaning composition. According to an embodiment of the present invention, the content of the vinyl polymer in the post CMP cleaning composition is 100 to 1000 ppm by mass, based on the total mass of the post CMP cleaning composition. According to an embodiment of the present invention, the content of the vinyl polymer in the post CMP cleaning composition is 50 to 500 ppm by mass, based on the total mass of the post CMP cleaning composition.

According to an embodiment of the present invention, the mass proportion of at least one selected from the vinyl polymer having a cyclic amide bond and the polyvinyl alcohol polymer in the vinyl polymers contained in the post CMP cleaning composition is 80% by mass or more, 90% by mass or more, 95% by mass or more, or 98% by mass or more (the upper limit: 100% by mass). According to an embodiment of the present invention, the mass proportion of polyvinylpyrrolidone in the vinyl polymers contained in the post CMP cleaning composition is 80% by mass or more, 90% by mass or more, 95% by mass or more, or 98% by mass or more (the upper limit: 100% by mass).

### (Chelating Agent)

According to an embodiment of the present invention, the post CMP cleaning composition contains a chelating agent. The chelating agent is a compound that is bonded to or forms a complex with a metal ion to form a soluble complex. According to an embodiment of the present invention, the chelating agent is a compound represented by C(R¹)(R²)(R³)(R⁴) or a salt thereof. Each of R¹ to R⁴ independently represents a hydrogen atom, a hydroxy group, a phosphonic acid group or a salt group thereof, or an alkyl group having 1 or more and 5 or less carbon atoms and optionally being substituted with a phosphonic acid group or a salt group thereof, and at this time, at least one selected from R¹ to R⁴ is a phosphonic acid group or a salt group thereof, or an alkyl group substituted with a phosphonic acid group or a salt group thereof. One or two phosphonic acid groups or salt groups thereof, or alkyl groups substituted with phosphonic acid groups or salt groups thereof may be contained in a molecule. Examples of the alkyl group having 1 or more and 5 or less carbon atoms as R¹ to R⁴ described above include alkyl groups such as a methyl group, an ethyl group, a propyl group, an isopropyl group, a butyl group, an isobutyl group, a sec-butyl group, or a tert-butyl group. Specific examples of the alkyl group substituted with a phosphonic acid group or a salt group thereof are the same as those. Examples of the salt include alkali metal salts such as a sodium salt and a potassium salt, salts of a group 2 element such as a calcium salt and a magnesium salt, an amine salt, and an ammonium salt.

According to an embodiment of the present invention, in C(R¹)(R²)(R³)(R⁴), two of R¹ to R⁴ are phosphonic acid groups or salt groups thereof, one of them is an alkyl group having 1 or more and 5 or less carbon atoms, and one of them is a hydroxy group.

Specific examples of the chelating agent include orthophosphoric acid, methyl acid phosphate, ethyl acid phosphate, ethyl glycol acid phosphate, isopropyl acid phosphate, butyl acid phosphate, 2-ethylhexyl acid phosphate, pentetic acid, phytic acid, edetic acid, 1-hydroxyethylidene-1,1-diphosphonic acid (HEDP, also referred to as etidronic acid), polyphosphoric acid, metaphosphoric acid, hexametaphosphoric acid, phosphonobutane tricarboxylic acid, ethylenediamine tetramethylene phosphonic acid, diethylene triamine pentamethylene phosphonic acid, aminotrimethylene phosphonic acid, or salts thereof.

According to an embodiment of the present invention, the content of the chelating agent in the post CMP cleaning composition is 5 ppm by mass or more, 10 ppm by mass or more, 30 ppm by mass or more, 50 ppm by mass or more, 70 ppm by mass or more, 90 ppm by mass or more, 110 ppm by mass or more, or 130 ppm by mass or more. According to an embodiment of the present invention, the content of the chelating agent in the post CMP cleaning composition is, for example, 1000 ppm by mass or less, 900 ppm by mass or less, 800 ppm by mass or less, 700 ppm by mass or less, 600 ppm by mass or less, 500 ppm by mass or less, 400 ppm by mass or less, 300 ppm by mass or less, or 200 ppm by mass or less, based on the total mass of the post CMP cleaning composition. According to an embodiment of the present invention, the content of the chelating agent in the post CMP cleaning composition is 5 ppm by mass or more and 1000 ppm by mass or less. When the content of the chelating agent in the post CMP cleaning composition is the above lower limit, upper limit, or range, the lifetime of the polishing pad can be improved, and also the number of defects after polishing can be reduced.

According to an embodiment of the present invention, the mass proportion of the chelating agent represented by C(R¹)(R²)(R³)(R⁴) in which two of R¹ to R⁴ are phosphonic acid groups or salt groups thereof, one of them is an alkyl group having 1 or more and 5 or less carbon atoms, and one of them is a hydroxy group in the chelating agents contained in the post CMP cleaning composition is 80% by mass or more, 90% by mass or more, 95% by mass or more, or 98% by mass or more (the upper limit: 100% by mass).

According to an embodiment of the present invention, the mass proportion of HEDP in the chelating agents contained in the post CMP cleaning composition is 80% by mass or more, 90% by mass or more, 95% by mass or more, or 98% by mass or more (the upper limit: 100% by mass).

### (Anionic Polymer)

According to an embodiment of the present invention, the post CMP cleaning composition contains an anionic polymer. The anionic polymer is a polymer having an anionic group such as a carboxylic acid group, a sulfonic acid group, or a phosphoric acid group. When the polymer has a structure containing a hydrophobic group as described above, the polymer is not an anionic polymer, but is included in the category of the surfactant. When the post CMP cleaning composition contains the anionic polymer, the lifetime of the polishing pad can be improved, and also the number of defects after polishing can be reduced.

According to an embodiment of the present invention, the anionic polymer is an anionic polymer that contains a sulfonic acid group. According to an embodiment of the present invention, the anionic polymer is a polymer that contains a sulfonic acid group and a carboxy group. According to an embodiment of the present invention, the anionic polymer is a copolymer that has a repeating unit having a sulfonic acid group and a repeating unit having a carboxy group. The copolymer may be a random copolymer or a block copolymer. According to an embodiment of the present invention, the anionic polymer contains a repeating unit derived from CH₂═C(R)—C(═O)—OH (wherein R is H or CH₃) and a repeating unit derived from CH₂═C(R)—C(═O)—NH—C(R′)₂—SO₃H (wherein R is H or CH₃, and R′ is an alkyl group having 1 to 4 carbon atoms). The alkyl group in R′ is an alkyl group having 1, 2, 3, or 4 carbon atoms. According to an embodiment of the present invention, examples of the anionic polymer include polyvinyl sulfonic acid, polystyrene sulfonic acid, polyallyl sulfonic acid, polymethallylsulfonic acid, poly(2-acrylamide-2-methylpropanesulfonic acid), polyisoprene sulfonic acid, a (meth)acrylic acid-isoprene sulfonic acid copolymer, a (meth)acrylic acid-[2-(meth)acrylamide-2-methylpropanesulfonic acid] copolymer, and a (meth)acrylic acid-isoprenesulfonic acid-[2-(meth)acrylamide-2-methylpropanesulfonic acid] copolymer.

According to an embodiment of the present invention, the weight average molecular weight of the anionic polymer is, for example, 1,500 or more, 3,000 or more, 4,000 or more, 5,000 or more, 6,000 or more, 7,000 or more, 8,000 or more, 9,000 or more, 10,000 or more, or 11,000 or more. According to an embodiment of the present invention, the weight average molecular weight of the anionic polymer is, for example, 100,000 or less, 90,000 or less, 80,000 or less, 70,000 or less, 60,000 or less, 50,000 or less, 40,000 or less, 30,000 or less, 20,000 or less, or 15,000 or less. According to an embodiment of the present invention, the weight average molecular weight of the anionic polymer is, for example, 1,500 or more and 100,000 or less. When the weight average molecular weight of the anionic polymer has the lower limit, upper limit, or range as described above, the lifetime of the polishing pad can be improved, and also the number of defects after polishing can be reduced.

According to an embodiment of the present invention, the content of the anionic polymer in the post CMP cleaning composition is, for example, 5 ppm by mass or more, 10 ppm by mass or more, 30 ppm by mass or more, 50 ppm by mass or more, 70 ppm by mass or more, 90 ppm by mass or more, or 110 ppm by mass or more, based on the total mass of the post CMP cleaning composition. According to an embodiment of the present invention, the content of the anionic polymer in the post CMP cleaning composition is, for example, 1000 ppm by mass or less, 900 ppm by mass or less, 800 ppm by mass or less, 700 ppm by mass or less, 600 ppm by mass or less, 500 ppm by mass or less, 400 ppm by mass or less, 300 ppm by mass or less, or 200 ppm by mass or less, based on the total mass of the post CMP cleaning composition. According to an embodiment of the present invention, the content of the anionic polymer in the post CMP cleaning composition is, 5 ppm by mass or more and 1000 ppm by mass or less, or 10 to 1000 ppm by mass. When the content of the anionic polymer in the post CMP cleaning composition has the above lower limit, upper limit, or range, the lifetime of the polishing pad can be improved, and also the number of defects after polishing can be reduced.

According to an embodiment of the present invention, the mass proportion of the copolymer that has a repeating unit having a sulfonic acid group and a repeating unit having a carboxy group in the anionic polymers contained in the post CMP cleaning composition is 80% by mass or more, 90% by mass or more, 95% by mass or more, or 98% by mass or more (the upper limit: 100% by mass). According to an embodiment of the present invention, the mass proportion of the anionic polymer that includes a repeating unit derived from CH₂═C(R)—C(═O)—OH (wherein R is H or CH₃) and a repeating unit derived from CH₂═C(R)—C(═O)—NH—C(R′)₂—SO₃H (wherein R is H or CH₃, and R′ is an alkyl group having 1 to 4 carbon atoms) in the anionic polymers contained in the post CMP cleaning composition is 80% by mass or more, 90% by mass or more, 95% by mass or more, or 98% by mass or more (the upper limit: 100% by mass).

### (Liquid Carrier)

According to an embodiment of the present invention, the post CMP cleaning composition contains a liquid carrier. The liquid carrier has a function of dispersing or dissolving each component. The liquid carrier preferably contains water. In addition, the liquid carrier may be a mixed solvent of water and an organic solvent to disperse or dissolve each component. In this case, examples of the organic solvent to be used include acetone, acetonitrile, ethanol, methanol, isopropanol, glycerin, ethylene glycol, and propylene glycol which are organic solvents miscible with water. These organic solvents may be used without being mixed with water, and may be mixed with water after dispersion or dissolution of each component. These organic solvents may be used alone or in combination of two or more. From the viewpoint of preventing the contamination of the polished object to be polished and the inhibition of the function of other components, water that contains residues as little as possible is preferable. For example, water having a total content of transition metal ions of 100 mass ppb or less is preferable. Herein, the purity of water can be increased by, for example, removing impurity ions with an ion exchange resin, removing foreign matters by a filter, or an operation such as distillation. Specifically, for example, deionized water (ion exchange water), pure water, ultrapure water, or distilled water is preferably used. In the present specification, the content of a transition metal ion can be measured by, for example, ICP atomic emission spectroscopy.

According to an embodiment of the present invention, 80% by mass or more, 85% by mass or more, 90% by mass or more, 95% by mass or more, or 99% by mass or more of the liquid carrier contained in the post CMP cleaning composition is constituted from water.

### <pH of Slurry>

According to an embodiment of the present invention, the pH of the post CMP cleaning composition is less than 7.0. The sulfonic acid group in the anionic polymer containing a sulfonic acid group discharges a hydrogen ion (H+) and is in an ionized state (R—SO₃—) also in a solution with a low pH value (e.g., in a solution with a pH of 2 to 4). Consequently, the anionic polymer containing a sulfonic acid group is adsorbed on the surface of the polished object to be polished and the abrasive grain residue, and can negatively control (convert) the zeta potentials of both of them. Accordingly, an electrostatic repulsion action is generated between the polished object to be polished and the abrasive grain residue, and the abrasive grain residue is efficiently desorbed from the polished object to be polished and can further be prevented from reattaching to the polished object to be polished. The anionic polymer containing a sulfonic acid group is particularly easily adsorbed to a film containing silicon nitride and can suitably exert the above effect in the film containing silicon nitride. According to an embodiment of the present invention, the pH of the post CMP cleaning composition is 6 or less, 5 or less, 4 or less, 3.9 or less, 3.7 or less, 3.5 or less, or 3.3 or less. According to an embodiment of the present invention, the pH of the post CMP cleaning composition is 2 or more, 2.2 or more, 2.4 or more, 2.6 or more, 2.8 or more, 3 or more, or 3.2 or more. According to an embodiment of the present invention, the pH of the post CMP cleaning composition is, for example, 2 or more and less than 7, 2 or more and 4 or less, or 2.5 or more and 3.5 or less. When the pH of the post CMP cleaning composition is adjusted to around 3, the lifetime of the polishing pad can be improved, and also the number of defects after polishing can be reduced. According to an embodiment of the present invention, a pH adjusting agent may be contained to eventually adjust the pH of the post CMP cleaning composition to the above pH. The pH adjusting agent is not particularly limited, and for example, a known acid or base, or salts thereof other than the aforementioned chelating agent may be used. Examples of the pH adjusting agent include organic acids such as carboxylic acids such as formic acid, acetic acid, propionic acid, butyric acid, valeric acid, caproic acid, enanthic acid, caprylic acid, pelargonic acid, capric acid, lauric acid, myristic acid, palmitic acid, margaric acid, stearic acid, oleic acid, linoleic acid, linolenic acid, arachidonic acid, docosahexaenoic acid, eicosapentaenoic acid, lactic acid, malic acid, citric acid, benzoic acid, phthalic acid, isophthalic acid, terephthalic acid, salicylic acid, gallic acid, mellitic acid, cinnamic acid, oxalic acid, malonic acid, succinic acid, glutaric acid, adipic acid, fumaric acid, maleic acid, aconitic acid, amino acid, and anthranilic acid, sulfonic acids, and organic phosphonic acids; inorganic acids such as nitric acid, carbonic acid, hydrochloric acid, hypophosphorous acid, phosphorus acid, phosphonic acid, boric acid, and hydrofluoric acid; alkali metal hydroxides such as potassium hydrate (KOH); alkali metal carbonates such as potassium carbonate (K₂CO₃) and sodium carbonate (Na₂CO₃); group 2 element hydroxides; ammonia (ammonium hydroxide); and organic bases such as quaternary ammonium hydroxide compounds. The content of the pH adjusting agent in the post CMP cleaning composition is only required to be appropriately selected in an amount such that the desired pH value of the post CMP cleaning composition is obtained. As the pH of the post CMP cleaning composition, the value measured by the method described in Examples is employed.

### (Other Additives)

According to an embodiment of the present invention, the post CMP cleaning composition may contain or may not contain other additives, as necessary, within a range of not impairing the effect of the present invention. Examples of other additives include an antifungal agent (antiseptic agent), dissolved gas, a reducing agent, and an oxidizing agent. Among the components contained in the post CMP cleaning composition, the oxidizing agent in the present specification refers to a compound having an action of oxidizing the polished object to be polished (object to be polished) and having a redox potential (E°) more positive than the standard redox potential of a substrate material. Examples thereof include hydrogen peroxide, nitric acid, chlorous acid, hypochlorous acid, periodic acid, persulfate, hydrogen oxides and adducts thereof such as urea hydrogen peroxide and carbonate, organic peroxides such as benzoyl, peracetic acid, and di-t-butyl, and sulfate (SO₅), sulfate (S₅O₈), and sodium peroxide. Examples also include iodous acid, hypoiodous acid, iodic acid, perbromic acid, bromous acid, hypobromous acid, bromic acid, chloric acid, perchloric acid, perboric acid, and salts thereof. Among the components contained in the post CMP cleaning composition, the reducing agent in the present specification refers to a compound having an action of reducing the polished object to be polished (object to be polished) and having a redox potential (E°) more negative than the standard redox potential of a substrate material. Examples thereof include sulfite reducing agents such as sodium sulfite, sodium hydrogen sulfite, and sodium thiosulfate, hydrazine reducing agents such as hydrazine and hydrazine monohydrate, and ascorbic acid reducing agents such as ascorbic acid and erythorbic acid.

According to an embodiment of the present invention, the pH of the post CMP cleaning composition is less than 7 (that is, acidic) and preferably contains a polymer. Thus, the post CMP cleaning composition also suitably contains an antifungal agent (antiseptic agent). The antifungal agent that can be used when the post CMP cleaning composition according to the present invention contains an antifungal agent is not particularly limited, and can be suitably selected depending on the type of polymer. Specific examples thereof include isothiazoline antiseptic agents such as 2-methyl-4-isothiazolin-3-on and 5-chloro-2-methyl-4-isothiazolin-3-on; methyl parahydroxybenzoate (methyl parahydroxybenzoate) and butyl parahydroxybenzoate (butyl parahydroxybenzoate); phenylphenol (2-phenylphenol, 3-phenylphenol, 4-phenylphenol); unsaturated fatty acids such as sorbic acid; 1,2-alkanesdiol such as 1,2-pentanediol, 1,2-hexanediol, and 1,2-octanediol; alkyl glyceryl ethers such as 2-ethylhexyl glycerylether (ethylhexylglycerin); capric acid, dehydroacetic acid, and phenoxyethanol. The lower limit of the content (concentration) of the antifungal agent when the post CMP cleaning composition contains an antifungal agent is not particularly limited, and is preferably 0.00006% by mass or more, more preferably 0.0006% by mass or more, still more preferably 0.0008% by mass or more, and particularly preferably 0.001% by mass or more, based on the total mass of the post CMP cleaning composition. In addition, the upper limit of the content (concentration) of the antifungal agent is not particularly limited, and is preferably 3% by mass or less, more preferably 0.6% by mass or less, still more preferably 0.3% by mass or less, and particularly preferably 0.06% by mass or less.

According to an embodiment of the present invention, the post CMP cleaning composition is substantially free of an oxidizing agent. The term “the post CMP cleaning composition is substantially free of an oxidizing agent” includes not only the case where the oxidizing agent is not contained in the post CMP cleaning composition at all (below the detection limit), but also the case where the oxidizing agent is contained in an amount of less than 0.01 ppm by mass. According to an embodiment of the present invention, the post CMP cleaning composition is substantially free of a reducing agent. The term “the post CMP cleaning composition is substantially free of a reducing agent” includes not only the case where the reducing agent is not contained in the post CMP cleaning composition at all (below the detection limit), but also the case where the reducing agent is contained in an amount of less than 0.01 ppm by mass.

According to an embodiment of the present invention, the post CMP cleaning composition is substantially consisting of a vinyl polymer, a chelating agent, an anionic polymer, a pH adjusting agent for adjusting the pH to a predetermined range, an aqueous carrier, and at least one selected from the surfactant and the antifungal agent. According to the present embodiment, the wear amount of the polishing pad, as determined in Wear Amount Test X when using the post CMP cleaning composition is preferably reduced to 0.037 mm³ or less. According to an embodiment of the present invention, the post CMP cleaning composition is substantially consisting of a vinyl polymer, a chelating agent, an anionic polymer, a pH adjusting agent, an aqueous carrier, and if necessary, the antifungal agent. According to the present embodiment, the wear amount of the polishing pad, as determined in Wear Amount Test X when using the post CMP cleaning composition is preferably reduced to 0.037 mm³ or less. The term “the post CMP cleaning composition is substantially consisting of a vinyl polymer, a chelating agent, an anionic polymer, a pH adjusting agent for adjusting the pH to a predetermined range, an aqueous carrier, and at least one selected from the surfactant and the antifungal agent” means that the total content of “a chelating agent, an anionic polymer, a pH adjusting agent for adjusting the pH to a predetermined range, an aqueous carrier, and at least one selected from the surfactant and the antifungal agent” is more than 99% by mass (the upper limit: 100% by mass), based on the total mass of the post CMP cleaning composition of 100% by mass. For example, the term “the post CMP cleaning composition is substantially consisting of a vinyl polymer, a chelating agent, an anionic polymer, a pH adjusting agent, an aqueous carrier, and if necessary, the antifungal agent” means that the total content of the vinyl polymer, the chelating agent, the anionic polymer, the pH adjusting agent, the aqueous carrier, and if necessary, the antifungal agent is more than 99% by mass (the upper limit: 100% by mass), based on the total mass of the post CMP cleaning composition of 100% by mass (relative to the post CMP cleaning composition).

According to an embodiment of the present invention, the post CMP cleaning composition substantially free of abrasive grains to further improve the effect of removing foreign matters. Herein, the term “substantially free of abrasive grains” means that the post CMP cleaning composition contains no abrasive grains at all (below the detection limit), or if it contains abrasive grains, the amount is less than 0.01% by mass or less than 0.001% by mass.

### <Method for Producing Post Chemical Mechanical Polishing Cleaning Composition (Post CMP Cleaning Composition)>

The slurry disclosed in the present specification may be a slurry (in particular, a post CMP cleaning composition) having a property of suppressing the wear amount of the polishing pad, as determined in Wear Amount Test X, to 0.037 mm³ or less. As described in the description regarding the surfactant and the description regarding the vinyl polymer, the present inventors consider that one of the factors of making the structure of the polishing pad (polyurethane) fragile is excess impartment of hydrophilicity to the polishing pad. Thus, in a slurry design, the impartment of hydrophilicity is preferably balanced so that the wear amount of the polishing pad, as determined in Wear Amount Test X, achieves 0.037 mm³ or less, while ensuring basic properties. For example, when a slurry containing the vinyl polymer having an amide bond and the anionic polymer is prepared, suitable blending is preferably performed so that respective components have the above values or less. As for the specific blending method, respective components are preferably mixed in the liquid carrier. The temperature at which respective components are mixed is not particularly limited, and is preferably 10° C. or more and 40° C. or less. In addition, the mixing time is not particularly limited.

### <Method for Preparing Polished Object to be Polished>

The slurry disclosed in the present invention is preferably used as the post chemical mechanical polishing cleaning composition (post CMP cleaning composition). The post CMP cleaning composition may be used for a cleaning of the polished object to be polished (from another viewpoint, since the treatment of the surface is carried out by cleaning, it may be referred to as the surface treatment, or may also be referred to as rinsing).

The polished object to be polished may be prepared by subjecting the object to be polished to chemical mechanical polishing (CMP) by using a polishing composition. Hereinafter, an example of CMP will be described.

The object to be polished may contain a silicon-containing material, for example, at least one selected from the group consisting of silicon oxide, polysilicon, and silicon nitride. The object to be polished is, for example, a semiconductor substrate.

As the polishing composition, for example, one containing abrasive grains, an aqueous carrier, a water-soluble polymer, and a pH adjusting agent is preferably used. Specific examples of such a polishing composition include a polishing composition containing silicon oxide (e.g., colloidal silica), polyvinylpyrrolidone, ammonia, and water. The average primary particle size of the abrasive grains is, for example, 10 nm or more, 15 nm or more, 20 nm or more, or 30 nm or more. The average primary particle size of the abrasive grains is, for example, 100 nm or less, 75 nm or less, or 50 nm or less. The average primary particle size of the abrasive grains is, for example, calculated based on the specific surface area of the content of the abrasive grain measured by the BET method. The average secondary particle size of the abrasive grains is, for example, 30 nm or more, 40 nm or more, or 50 nm or more. The average secondary particle size of the abrasive grains is, for example, 200 nm or less, 100 nm or less, or 80 nm or less. The average secondary particle size of the abrasive grains can be measured by the dynamic light scattering method.

When the polishing composition is used as it is as a polishing liquid (POU), the content of the abrasive grains may be 0.1% by mass or more, 0.4% by mass or more, or 1.0% by mass or more relative to the polishing composition. In addition, the content of the abrasive grains may be 10% by mass or less, 5% by mass or less, or 3% by mass or less.

As for the pH adjusting agent and the liquid carrier, the above explanations can be appropriately referred to. Also, as for the water-soluble polymer, the explanations of the vinyl polymer described above and the like can be appropriately referred to.

As the polishing apparatus, a common polishing apparatus equipped with a holder for holding an object to be polished, a motor capable of changing the rotation speed, and the like, and having a polishing table (platen) to which a polishing pad (polishing cloth) can be attached, can be used. As the polishing apparatus, either a single-side polishing apparatus or a double-side polishing apparatus may be used. As the polishing pad, common non-woven fabric, polyurethane, porous fluororesin, or the like can be used without particular limitation. The polishing pad is preferably subjected to grooving (e.g., embossing a grid-shaped pattern) such that the polishing liquid accumulates therein. The Shore A hardness of the polishing pad used in CMP may be 60 or more and 95 or less, or 75 or more and 95 or less. In the present specification, the Shore A hardness may be measured by a method in accordance with JIS K 6253-3:2012.

As for the polishing conditions, the rotation speed of the polishing table and the head (carrier) rotation speed are preferably 10 rpm or more and 100 rpm or less, and the pressure applied to the object to be polished (polishing pressure) is preferably 0.5 psi or more and 10 psi or less. The method for supplying the polishing composition to the polishing pad is also not particularly limited, and for example, a continuous supply method with a pump or the like (pouring) is employed. The supply rate is not limited, but is preferably such that the surface of the polishing pad be constantly covered with the polishing composition, and is preferably 10 mL/min or more and 5000 mL/min or less. The polishing time is also not particularly limited, and is preferably 5 seconds or more and 180 seconds or less in the step using the polishing composition.

### <Post CMP Cleaning Treatment>

The slurry disclosed in the present invention is preferably used as the post CMP cleaning composition, and the post CMP cleaning composition may be used in the cleaning of the polished object to be polished. The post CMP cleaning treatment may subsequently include, for example, cleaning with a brush such as a PVA brush or cleaning with water. The description will be made hereinafter.

The post CMP cleaning treatment is carried out by bringing the post CMP cleaning composition into direct contact with the polished object to be polished. Specifically, in the post CMP cleaning treatment, the friction with the polishing pad is utilized on the polishing table (platen). Specifically, it can be carried out by installing the surface of the polished object to be polished on the polishing table (platen) of the polishing apparatus, bringing the polishing pad into contact with the polished object to be polished, and relatively sliding the polished object to be polished and the polishing pad while supplying the post CMP cleaning composition to the contact part.

As the polishing apparatus, a common polishing apparatus equipped with a holder for holding an object to be polished, a motor capable of changing the rotation speed, a cleaning brush, and the like, and having a polishing table to which a polishing pad (polishing cloth) can be attached, can be used.

The polishing pad is preferably a polyurethane pad. The polishing pad is preferably subjected to grooving (e.g., embossing a grid-shaped pattern) such that the post CMP cleaning composition accumulates therein. The Shore A hardness of the polishing pad is, for example, 60 to 90. As for the polishing conditions when the post CMP cleaning treatment is carried out, the rotation speed of the polishing table (platen) and the head (carrier) rotation speed may be 10 rpm or more and 100 rpm or less, 40 rpm or more and 90 rpm or less, or 60 rpm or more and 80 rpm or less. The pressure applied to the polished object to be polished (polishing pressure) is, for example, 0.5 psi or more and 10 psi or less, 0.7 psi or more and 7 psi or less, or 1 psi or more and 3 psi or less. As the method for supplying the post CMP cleaning composition to the polishing pad, a continuous supply method with a pump or the like (pouring) is employed. The surface of the polishing pad is preferably, constantly covered with the post CMP cleaning composition, and the supply rate of the post CMP cleaning composition may be 10 mL/min or more and 5000 mL/min or less, 50 mL/min or more and 800 mL/min or less, or 100 mL/min or more and 500 mL/min or less. The post CMP cleaning treatment time is also not particularly limited, and may be 5 seconds or more and 180 seconds or less, 15 seconds or more and 120 seconds or less, or 30 seconds or more and 60 seconds or less.

The cleaning brush is not particularly limited, and is preferably a brush made of resin. The material of the brush made of resin is not particularly limited, and PVA (polyvinyl alcohol) is preferable. The cleaning brush is more preferably a sponge made of PVA. The brush cleaning using the cleaning brush is preferably carried out while supplying aqueous ammonia.

The embodiments of the present invention are described in detail, but these are exemplary and illustrative purposes and not restrictive, and it is apparent that the scope of the present invention should be interpreted by the accompanying claims.

The present invention includes the following aspects and embodiments.
1. A slurry having a property of suppressing the wear amount of a polishing pad, as determined in Wear Amount Test X, to 0.037 mm³ or less.
2. The slurry according to 1., wherein the slurry is a post chemical mechanical polishing cleaning composition.
3. The slurry according to 1, or 2., wherein a concentration of a surfactant is 1000 ppm by mass or less.
4. The slurry according to any one of 1. to 3., wherein the slurry comprises a vinyl polymer, and a concentration of the vinyl polymer is 10 to 10000 ppm by mass.
5. The slurry according to 4., wherein the concentration of the vinyl polymer is 100 to 1000 ppm by mass.
6. The slurry according to 4, or 5., wherein the vinyl polymer comprises a heteroatom-containing vinyl polymer.
7. The slurry according to 6., wherein the heteroatom-containing vinyl polymer has at least one selected from an amide bond and a hydroxy group.
8. The slurry according to 7., wherein the vinyl polymer comprises at least one selected from the group consisting of polyvinylpyrrolidone, poly-N-vinylacetamide, polydimethylacrylamide, polyvinylcaprolactam, N-isopropylacrylamide, an oxazoline group-containing polymer, and a polyvinyl alcohol polymer.
9. The slurry according to 1. to 8., wherein the slurry comprises an anionic polymer, and a concentration of the anionic polymer is 10 to 1000 ppm by mass.
10. The slurry according to 9., wherein the anionic polymer is an anionic polymer containing a sulfonic acid group.
11. The slurry according to any one of 1. to 10., further comprising a chelating agent.
12. The slurry according to any one of 1. to 11., being substantially free of abrasive grains.
13. The slurry according to any one of 1. to 12., wherein the slurry comprises: 100 to 1000 ppm by mass of a vinyl polymer having an amide bond; 5 ppm by mass or more and 1000 ppm by mass or less of a chelating agent represented by the formula: C(R¹)(R²)(R³)(R⁴), wherein two of R¹ to R⁴ are phosphonic acid groups or salt groups thereof, one of them is an alkyl group having 1 or more and 5 or less carbon atoms, and one of them is a hydroxy group; and 10 to 1000 ppm by mass of a copolymer that has a repeating unit having a sulfonic acid group and a repeating unit having a carboxy group, and has a pH of 2 or more and 4 or less.
14. A slurry comprising a vinyl polymer having an amide bond, a chelating agent, and an anionic polymer, the slurry having a pH of less than 7.
15. The slurry according to 14, wherein the slurry comprises: 100 to 1000 ppm by mass of a vinyl polymer having an amide bond; 5 ppm by mass or more and 1000 ppm by mass or less of a chelating agent represented by the formula: C(R¹)(R²)(R³)(R⁴), wherein two of R¹ to R⁴ are phosphonic acid groups or salt groups thereof, one of them is an alkyl group having 1 or more and 5 or less carbon atoms, and one of them is a hydroxy group; and 10 to 1000 ppm by mass of a copolymer that has a repeating unit having a sulfonic acid group and a repeating unit having a carboxy group, and has a pH of 2 or more and 4 or less.
16. The slurry according to 14. or 15., wherein the slurry is a post chemical mechanical polishing cleaning composition.
17. The slurry according to any one of 14. to 16., wherein the slurry has a property of suppressing the wear amount of the polishing pad, as determined in Wear Amount Test X, to 0.037 mm³ or less.
18. A method for evaluating damage caused by a slurry to a polishing pad, comprising: a step of subjecting the slurry and the polishing pad to contact treatment to obtain a treated pad, a step of applying scratches to the treated pad using a static friction measuring machine, and a step of obtaining a wear amount value of the polishing pad from a volume of the scratches using a laser microscope.
19. The method according to 18., wherein the polishing pad has a Shore A hardness of 60 to 90.
20. A kit comprising the slurry according to any one of 1. to 17, and a polishing pad having a Shore A hardness of 60 to 90.
21. A method for prolonging the lifetime of a polishing pad while using a slurry, wherein the slurry is the slurry according to any one of 1. to 17., and the polishing pad has a Shore A hardness of 60 to 90.

### EXAMPLES

The present invention will be described further in detail by way of the following Examples and Comparative Examples. However, the technical scope of the present invention is not limited to the following Examples only. Unless otherwise indicated, “%” and “part” mean “% by mass” and “part by mass”, respectively. In the following Examples, unless otherwise indicated, operations were performed under the conditions of room temperature (25° C.)/relative humidity of 40% RH or more and 50% RH or less.

### <Preparation of Slurry of Example 1>

An additive 1: PVP (polyvinylpyrrolidone; weight average molecular weight: 45000) as a vinyl polymer, an additive 3: HEDP (1-hydroxyethane-1,1-diphosphonic acid) as a chelating agent, an additive 4: a copolymer of acrylic acid and a sulfonic acid group-containing monomer (weight average molecular weight: 12000; described as “A” in Table) as an anionic polymer, and ammonia as a pH adjusting agent were mixed in water so as to have the composition and pH in Table 1, thereby preparing a slurry 1.

### [Weight Average Molecular Weight (Mw)]

As for the weight average molecular weight (Mw), the value of the weight average molecular weight (in terms of polyethylene glycol) measured by gel permeation chromatography (GPC) was used. The weight average molecular weight was measured by the following apparatus under the following conditions:
GPC apparatus: manufactured by SHIMADZU CORPORATION
Model name: Prominence+ELSD detector (ELSD-LTII)
Column: VP-ODS (manufactured by SHIMADZU CORPORATION)
Mobile phase A: MeOH
   B: 1% aqueous acetic acid solution
Flow rate: 1 mL/min
Detector: ELSD temp. 40° C., Gain 8, N₂GAS 350 kPa
Oven temperature: 40° C.
Injection volume: 40 μL.
   [Measurement of pH]

The pH of the slurry (liquid temperature: 25° C.) was confirmed with a pH meter (product name: LAQUA® manufactured by Horiba, Ltd.).

### <Preparation of Slurries of Other Examples>

Each of other slurries was prepared in the same manner as the slurry 1, except that the composition of Example 1 was changed to the composition and pH as shown in Table 1. In Table, the description “-” (hyphen) indicates that the compound is not added. In certain examples, each of the compound described in Table 1 was incorporated as an additive 2: a surfactant.

[Treatment with Slurry for Wear Amount Test X]

Sixty pieces of silicon wafers (300 mm, blanket wafer, manufactured by ADVANTEC CO., LTD.) in which a TEOS film having a thickness of 10000 Å was formed on the surface, were prepared, and subjected to treatment with a slurry under the following conditions one by one. The treatment with the slurry (cleaning) of the first piece was performed using a brand-new polishing pad, and the polishing pad was continuously used until the cleaning of 60 pieces was finished, without replacing the polishing pad with a brand-new one. Thus, the time for the treatment with the slurry is 60×10 minutes=10 hours.
Polishing apparatus: Reflection LK manufactured by Applied Materials, Inc.
Polishing pad: foamed polyurethane pad H800 (Shore A hardness: 89) manufactured by FUJIBO HOLDINGS, INC.
Conditioner (dresser): diamond dresser (manufactured by 3M Japan Limited)
Polishing pressure: 1.0 psi
Polishing table rotation speed: 80 rpm
Head rotation speed: 80 rpm
Supply of slurry: pouring
Supply rate of slurry: 300 mL/min
Slurry treatment time: 10 minutes.

The slurry may be a CMP slurry as mentioned above, or may be a post CMP slurry such as a rinsing agent.

### [Wear Amount Test X]

The wear amount test X is a test for obtaining a wear amount (mm³) by conducting a method including a step of subjecting a slurry and a polishing pad to slide contact treatment to obtain a treated pad, a step of applying scratches to the treated pad using a static friction measuring machine, and a step of obtaining a wear amount value of the polishing pad from a volume of the scratches using a laser microscope. Consequently, the damage caused by the slurry to the polishing pad can be evaluated. A specific method for the wear amount test X is as follows.

### (1) Step of Obtaining Treated Pad

The treated pad used for Wear Amount Test X was the same pad obtained in the above-described [treatment with slurry for wear amount test X]i.e., the pad taken after the sixtieth TEOS film had been polished.

### (2) Step of Applying Scratches

A piece measuring 4 cm×2 cm was cut from the treated pad, affixed to a static friction measuring machine (model TL-201Tt, Trinity-Lab Inc.), and fitted with the supplied sapphire stylus. Scratches were then produced under the following conditions: load, 200 g; number of reciprocating strokes, 10 (single pass); and indenter speed, 5 mm/sec.

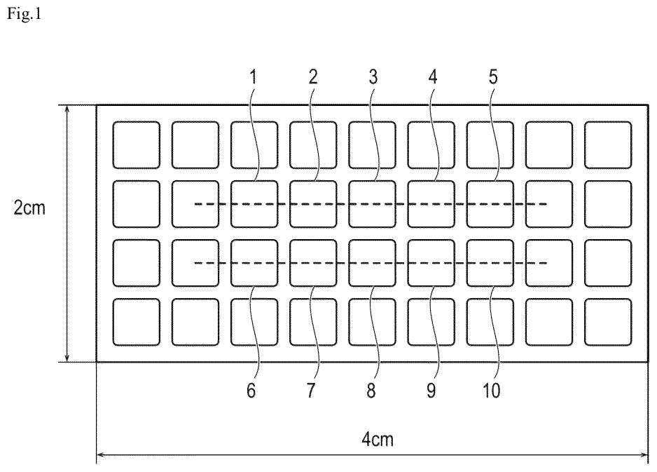

When the polishing pad had a pre-formed grid-shaped emboss pattern, which was used in the present Examples and Comparative Examples, the length of each scratch formed in the plane direction of the polishing pad was adjusted so that the scratch would traverse five grid cells, excluding the two grid cells in which the scratch started and ended. Two scratches were made on the same pad, thereby producing scratches across a total of ten grid cells. FIG. 1 is a schematic view of a treated polishing pad in which two scratches have been made so that they traverse five grid cells each, thereby providing a total of ten scratched grid cells on the pad. When a polishing pad that is not pre-embossed with a grid-shaped pattern is used, equivalent grid markings may be applied as needed, and scratches of the same size may be formed in the same manner.

### (3) Step of Obtaining Wear Amount Value

Scratches on the polishing pad were imaged with a laser microscope (model VK-X200, KEYENCE) using a 20× eyepiece and a 10× objective lens. The pad was positioned so that the scratches lay at the center of the field of view during imaging. Image analysis was performed with the bundled software (Observation Application VK-H1XV). In the software, “Image Processing” >“Tilt Correction” was selected to carry out tilt correction. Next, “Curvature Correction (Profile)” was applied, and the image was adjusted so that the height of the scratch-free area (displayed in red on the screen) was taken as the baseline. The corrected image was then analyzed by selecting “Measurement/Analysis”>“Volume & Area.”

Next, “Area” was selected, and the measurement window was adjusted so that the pores of the pad fell outside the window; in other words, the window was positioned so that it encompassed only the region containing scratches. In the present Examples and Comparative Examples, the window size was set to 1,409.855 μm (horizontal)×300 μm (vertical). “Wear Amount” was then selected, and the corresponding value was recorded. This procedure was carried out for ten individual grid cells, and the arithmetic mean of the ten values was taken as the wear amount. This evaluation method allows ten or more data points to be collected in a single operation, offering an advantage not achieved by conventional techniques.

### [Wear Amount Test Y]

The wear amount was measured in the same manner as in the Wear Amount Test X, except that the above (1) step of obtaining a treated pad was changed as follows.

500 ml of each slurry put in a polyethylene bottle was heated to 60° C., and a brand-new polishing pad (H800 manufactured by Fujibo Holdings, Inc.) was immersed therein and taken out after the elapse of 5 days. During immersing, the polyethylene bottle was stored in an air bath at 60° C. so that the slurry temperature was adjusted to 60° C.±2° C. The moisture of the polishing pad taken out was blown with air, and the polishing pad was dried at room temperature for 12 hours. Thus, the treated pad was obtained.

### [Measurement of Pad Life]

Pad life was defined as the time (hours, h) required for the number of defects detected with a wafer inspection apparatus (“SURFSCAN SP5,” KLA-Tencor, DCO mode) to increase by 20% while the above slurry treatment was continuously carried out using a single pad. Pad life thus represents the time to end-of-life caused by the generation of scratches, particle residues or organic residues.

### [Measurement of Number of Defects]

### (CMP Step)

As the objects to be polished, (1) a silicon wafer in which a silicon nitride (Si₃N₄) film having a thickness of 2500 Å was formed on the surface (also referred to as a Si₃N₄ substrate) (300 mm, blanket wafer, manufactured by ADVANTEC CO., LTD.), (2) a silicon wafer in which a TEOS film having a thickness of 10000 Å was formed on the surface (also referred to as a TEOS substrate herein) (300 mm, blanket wafer, manufactured by ADVANTEC CO., LTD.), and (3) a silicon wafer in which a polycrystalline silicon film having a thickness of 5000 Å was formed on the surface (also referred to as a Poly-Si substrate or a polysilicon substrate herein) (300 mm, blanket wafer, manufactured by D&X Co., Ltd.) were prepared. Note that, 1 Å=0.1 nm.

The Poly-Si substrate, TEOS substrate, and Si₃N₄ substrate prepared above were polished using a polishing composition (composition: a slurry containing 10% by mass of colloidal silica (average primary particle size 35 nm, average secondary particle size 70 nm), 0.25% by mass of polyvinylpyrrolidone, and 0.33% by mass of ammonia (ammonium hydroxide), was diluted to 5 times) under the following conditions. Note that, 1 rpm=0.017 s⁻¹.
Polishing apparatus: CMP single-side polishing apparatus for 300 mm, Reflexion LK manufactured by Applied Materials, Inc.
Polishing pad: foamed polyurethane pad H800 manufactured by FUJIBO HOLDINGS, INC.
Conditioner (dresser): nylon brush
Polishing pressure: 2.0 psi (1 psi=6894.76 Pa, the same applies hereinafter)
Polishing table rotation speed: 80 rpm
Head rotation speed: 80 rpm
Supply of polishing composition: pouring
Supply rate of polishing composition: 200 mL/min
Polishing time: 60 seconds.

### (Post CMP Cleaning Step)

After the surface of the object to be polished was polished in the above CMP step, the polished object to be polished was taken out from the polishing table (platen). Subsequently, the polished object to be polished was attached onto another polishing table (platen) in the same polishing apparatus, and the surface of the polished object to be polished was subjected to post CMP cleaning treatment using the slurry prepared above (post CMP cleaning composition) under the following conditions.
Polishing apparatus: CMP single-side polishing apparatus for 300 mm, Reflexion LK manufactured by Applied Materials, Inc.
Polishing pad: foamed polyurethane pad H800 manufactured by FUJIBO HOLDINGS, INC.
Conditioner (dresser): diamond dresser (manufactured by 3M Japan Limited)
Polishing pressure: 1.0 psi
Table rotation speed: 80 rpm
Supply of post CMP cleaning composition: pouring
Supply rate of post CMP cleaning composition: 300 mL/min
Polishing time: 60 seconds.

After the post CMP cleaning step, the substrate surface was subjected to PVA brush cleaning using a 0.3% by mass aqueous NH₃ solution for 20 seconds, and thereafter subjected to cleaning using deionized water for 40 seconds.

In each of the Si₃N₄ substrate, TEOS substrate, and Poly-Si substrate subjected to the cleaning treatment by the method described in the above post CMP cleaning step, the number of residues on the surface was evaluated. Specifically, in the residual part obtained by excluding a part having a width of 5 mm from the outer peripheral end part (the part from the width of 0 mm until the width of 5 mm, when the outer peripheral end was taken as 0 mm) of the single side of the polished Si₃N₄ substrate, TEOS substrate, and Poly-Si substrate, the number of residues (abrasive grain residues) having a diameter of 40 nm or more was counted for the Si₃N₄ substrate and the TEOS substrate, and the number of residues (abrasive grain residues) having a diameter of 70 nm or more was counted for the Poly-Si substrate using an optical inspection device Surfscan® SP5 manufactured by KLA-Tencor Corporation.

TABLE 1

| | Additive 1 | | Additive 2 | | Additive 3 | | Additive 4 | |
|---|---|---|---|---|---|---|---|---|
| | | Concentration | | Concentration | | Concentration | | Concentration |
| | Compound | [ppm by mass] | Compound | [ppm by mass] | Compound | [ppm by mass] | Compound | [ppm by mass] |
| E1 | PVP | 125 | — | 0 | HEDP | 150 | A | 118 |
| C1 | PVA | 100 | POE | 1000 | HEDP | 150 | A | 118 |
| | | | alkyl ether | | | | | |
| C2 | PVA | 100 | Ammonium | 900 | HEDP | 150 | A | 118 |
| | | | lauryl sulfate | | | | | |
| E2 | PVA | 100 | POE | 100 | HEDP | 150 | A | 118 |
| | | | alkyl ether | | | | | |
| C3 | — | 0 | — | 0 | HEDP | 150 | A | 118 |
| E3 | PVP | 10000 | — | 0 | HEDP | 150 | A | 118 |
| E4 | PVP | 1000 | — | 0 | HEDP | 150 | A | 118 |
| E5 | PVP | 500 | — | 0 | HEDP | 150 | A | 118 |
| E6 | PVP | 10 | — | 0 | HEDP | 150 | A | 118 |
| E7 | PVA | 10000 | — | 0 | HEDP | 150 | A | 118 |
| E8 | PVA | 1000 | — | 0 | HEDP | 150 | A | 118 |
| E9 | PVA | 250 | — | 0 | HEDP | 150 | A | 118 |
| E10 | PVA | 10 | — | 0 | HEDP | 150 | A | 118 |
| C4 * | HEC | 100 | POE | 1000 | — | — | — | — |
| | | | alkyl ether | | | | | |

| | pH adjusting | | Wear amount | Wear amount | Pad | Number of defects | | |
|---|---|---|---|---|---|---|---|---|
| | agent | pH | test X | test Y | life | SiN | TEOS | poly-Si |
| | Component | [—] | [mm [symbol] ] | [mm [symbol] ] | [H] | [Number] | [Number] | [Number] |
| E1 | NH₃ | 3.0 | 0.0305 | 0.0612 | 40 | 442 | 4531 | 2875 |
| C1 | NH₃ | 3.0 | 0.0411 | 0.0661 | 15 | 4865 | 9116 | 23154 |
| C2 | NH [symbol] | 3.5 | 0.0402 | 0.0650 | 15 | 1236 | 7653 | 2435 |
| E2 | NH₃ | 3.0 | 0.0360 | 0.0640 | 20 | 5028 | 5924 | 1261 |
| C3 | NH₃ | 3.0 | 0.0380 | 0.0556 | 18 | 11453 | 24526 | 1287 |
| E3 | NH [symbol] | 3.0 | 0.0360 | 0.0640 | 20 | 905 | 8765 | 5897 |
| E4 | NH3 | 3.0 | 0.0310 | 0.0610 | 35 | 595 | 7359 | 4869 |
| E5 | NH3 | 3.0 | 0.0310 | 0.0610 | 35 | 521 | 6532 | 4869 |
| E6 | NH₃ | 3.0 | 0.0370 | 0.0560 | 20 | 1457 | 12467 | 4258 |
| E7 | NH₃ | 3.0 | 0.0360 | 0.0610 | 20 | 1875 | 5803 | 9265 |
| E8 | NH [symbol] | 3.0 | 0.0343 | 0.0610 | 30 | 1237 | 5803 | 2875 |
| E9 | NH₃ | 3.0 | 0.0350 | 0.0600 | 30 | 1034 | 5386 | 3109 |
| E10 | NH₃ | 3.0 | 0.0370 | 0.0560 | 20 | 2057 | 8945 | 23154 |
| C4 * | HNO [symbol] | 3.0 | 0.0390 | 0.0635 | 13 | 3256 | 14362 | 25679 |

E: Example
C: Comparative Example
PVP: polyvinylpyrrolidone (weight average molecular weight: 45000)
PVA: polyvinyl alcohol (weight average molecular weight: 10000)
POE alkyl ether: polyoxyethylene dodecyl ether (average number of moles added: 10)
HEDP: 1-hydroxyethylidene-1,1-diphosphonic acid
HEC: hydroxyethylcellulose (weight average molecular weight: 250000)
A: a copolymer of acrylic acid and a sulfonic acid group-containing monomer (weight average molecular weight 12000)
* Comparative Example 4 has a composition of a post chemical mechanical polishing cleaning composition (rinsing agent) typically used in the art. [symbol]
indicates data missing or illegible when filed

In the above experimental examples, results in which the wear amount of the polishing pad, as determined in Wear Amount Test X, was 0.037 mm³ or less and results in which the wear amount of the polishing pad, as determined in Wear Amount Test X, was more than 0.037 mm³ were obtained. It was found that the pad life was as long as 20 hours or more in the case of using the former slurry, whereas the pad life was as short as less than 20 hours in the case of using the latter slurry. Thus, it is found that the numerical value of the wear amount, as determined in Wear Amount Test X, is fully correlated with the actual pad life. Hence, it can be concluded that the short lifetime of the polishing pad can be suppressed according to the former slurry.

What is interesting in the above experimental results is that the results of the Wear Amount Test Y in which the treated pad is obtained by immersing a polishing pad in the slurry is not necessarily correlated with the actual pad life. This means that the lifetime of the polishing pad is affected by not only simple chemical stimulation received from the slurry, but also mechanical stimulation received from the object to be polished (polished object to be polished) and locally generated heat due to the mutual sliding of the polishing pad and the object to be polished (polished object to be polished) in the polishing apparatus. Hence, providing a slurry having a property of suppressing the wear amount of the polishing pad, as determined in Wear Amount Test X, to 0.037 mm³ or less contributes to suppress the short lifetime of the polishing pad, in consideration of such various factors. The wear amount test X is an unconventional test including an index of the effect of protecting a polishing pad with a slurry.

Hence, in the present specification, a method for evaluating damage caused by a slurry to a polishing pad, comprising a step of subjecting the slurry and the polishing pad to contact treatment to obtain a treated pad, a step of applying scratches to the treated pad using a static friction measuring machine, and a step of obtaining a wear amount value of the polishing pad from a volume of the scratches using a laser microscope, is provided. The contact between the slurry and the polishing pad is typically carried out by a sliding contact of the slurry with the polishing pad, as carried out in the wear amount test X, but may be carried out by immersing the polishing pad in the slurry, as carried out in the Wear Amount Test Y.

It was also demonstrated that a lifetime of a polishing pad was prolonged by using the slurry having the wear amount of the polishing pad, as determined in Wear Amount Test X, of 0.037 mm³ or less. Hence, in another aspect, a method for prolonging the lifetime of a polishing pad even when a slurry is used, wherein the slurry is the slurry disclosed in the present specification, and the polishing pad has a Shore A hardness of 60 to 90, is provided in the present specification. The above explanations can be applied to the explanations of the slurry and the explanations of the polishing pad in the above method. In addition, in another aspect, a kit including the slurry and a polishing pad having a Shore A hardness of 60 to 90 is provided in the present specification. To conduct such a kit, the slurry and the polishing pad are not necessarily combined for sales and the like. These may also be stored in different bases. In addition, the manufacturer of the slurry may be different from the manufacturer of the polishing pad. The kid is conducted at the time when these are prepared to carry out, for example, the post CMP step using the slurry and the polishing pad. The above explanations can be applied to the explanations of the slurry and the explanations of the polishing pad in the above kit.

The present application claims priority based on Japanese Patent Application No. 2025-047838 filed on Mar. 24, 2025, which is incorporated herein by reference in its entirety.

1. A slurry having a property of suppressing the wear amount of a polishing pad, as determined in Wear Amount Test X, to 0.037 mm³ or less.

2. The slurry according to claim 1, wherein the slurry is a post chemical mechanical polishing cleaning composition.

3. The slurry according to claim 1, wherein a concentration of a surfactant is 1000 ppm by mass or less.

4. The slurry according to claim 1, wherein the slurry comprises a vinyl polymer, and a concentration of the vinyl polymer is 10 to 10000 ppm by mass.

5. The slurry according to claim 4, wherein the concentration of the vinyl polymer is 100 to 1000 ppm by mass.

6. The slurry according to claim 4, wherein the vinyl polymer comprises a heteroatom-containing vinyl polymer.

7. The slurry according to claim 6, wherein the heteroatom-containing vinyl polymer has at least one selected from an amide bond and a hydroxy group.

8. The slurry according to claim 7, wherein the vinyl polymer comprises at least one selected from the group consisting of polyvinylpyrrolidone, poly-N-vinylacetamide, polydimethylacrylamide, polyvinylcaprolactam, N-isopropylacrylamide, an oxazoline group-containing polymer, and a polyvinyl alcohol polymer.

9. The slurry according to claim 1, wherein the slurry comprises an anionic polymer, and a concentration of the anionic polymer is 10 to 1000 ppm by mass.

10. The slurry according to claim 9, wherein the anionic polymer is an anionic polymer containing a sulfonic acid group.

11. The slurry according to claim 1, further comprising a chelating agent.

12. The slurry according to claim 2, being substantially free of abrasive grains.

13. A method for evaluating damage caused by a slurry to a polishing pad, comprising:
a step of subjecting the slurry and the polishing pad to contact treatment to obtain a treated pad,
a step of applying scratches to the treated pad using a static friction measuring machine, and
a step of obtaining a wear amount value of the polishing pad from a volume of the scratches using a laser microscope.

14. The method according to claim 13, wherein the polishing pad has a Shore A hardness of 60 to 90.

15. A kit comprising the slurry according to claim 1, and a polishing pad having a Shore A hardness of 60 to 90.

16. A method for prolonging the lifetime of a polishing pad even when a slurry is used, wherein the slurry is the slurry according to claim 1, and the polishing pad has a Shore A hardness of 60 to 90.
